(19) United States
(12) Patent Application Publication
(10) Pub. No.: US 2009/0314221 A1
(43) Pub. Date: Dec. 24, 2009

(54) PET TOY FOR DISPENSING TREATS

(75) Inventor: Yueh Yu Wang, Kwun Tong (HK)

Correspondence Address: MARSH, FISCHMANN & BREYFOGLE LLP, 8055 East Tufts Avenue, Suite 450, Denver, CO, 80237, US

(73) Assignee: TOPET (H.K.) CO., LIMITED, Kwun Tong (HK)

(21) Appl. No.: 12/143,513

(22) Filed: Jun. 20, 2008

(51) Int. Cl. A01K 29/00

(52) U.S. Cl. 119/707

(57) ABSTRACT

A pet toy adapted for dispensing treats when the pet toy is manipulated by a pet animal, and a method for dispensing treats to a pet animal. The pet toy can include a housing having an interior surface defining a treat cavity for containing pet treats. The housing includes at least a first housing aperture. A rotatable lid is attached to the housing and is disposed over the first housing aperture where the rotatable lid includes at least a first lid aperture such that the rotatable lid can be rotated to expose the first housing aperture for the passage of treats through the housing. At least one of the housing and the rotatable lid includes a second aperture of smaller size than either the first housing aperture or the lid aperture such that the lid can be rotated to form a treat outlet passageway that is smaller than the treat inlet passageway.

### BACKGROUND OF THE INVENTION

1. Field of the Invention

The present invention relates to a pet toy for the amusement of a pet animal. More particularly, the present invention relates to a pet toy that is adapted to release treats when the pet toy is manipulated by the pet animal to encourage the pet animal to continue playing with the pet toy.

2. Description of Related Art

There are several devices disclosed in the prior art for the amusement of pet animals, where the device dispenses treats or similar edible items as the device is manipulated by the animal.

U.S. Pat. No. 6,557,496 by Herrenbruck discloses a treat dispensing toy that also includes a noise-producing sound unit. Edible treats can be loaded into a treat cavity by removing the sound unit from the device and placing treats within the cavity. As the animal manipulates the pet toy, the treats can gravitate toward an exit at the opposite side of the housing through which the treats are dispensed.

U.S. Pat. No. 6,098,571 by Axelrod et al. discloses an animal treat dispensing toy that regulates the delivery of a pet treat of a selected size and shape when the device is moved by the pet. The device includes an inner housing for containing the pet treat of a selected size and shape where the housing includes one or more openings for dispensing the treat when the device is moved by the pet. The device also includes an outer housing to contain the inner housing, where the inner housing is movable within the outer housing.

U.S. Pat. No. 5,758,604 by Jorgensen discloses a toy for animals that includes a hollow body having an inner labyrinth. A pet treat can be placed within the hollow body and can move along the labyrinth as the animal manipulates the hollow body until the treat is discharged out an exit.

U.S. Pat. No. 6,073,581 by Wang discloses a ball-like dog toy that includes a spherical shell and a cylindrical valve where dog food is discharged out of the spherical shell through the cylindrical valve when the shell is rolled on the ground. Discharging of the dog food is stopped when the dog stops playing with the dog toy.

It would be advantageous to provide a pet toy for the amusement of a pet animal that controllably releases treats or similar edible items to encourage the pet to continue playing with the toy. It would be advantageous if the edible treats could be easily and rapidly loaded into the toy. It would also be advantageous if the outlet for the treats could be closed so that the animal can continue playing with the toy without the ability to access and consume additional treats that are disposed within the toy.

### SUMMARY OF THE INVENTION

Accordingly, the present invention provides a pet toy adapted to dispense treats to a pet animal when the pet toy is manipulated by the pet animal. The present invention also provides a method for dispensing treats to a pet animal.

According to one embodiment, a pet toy is provided that is adapted to dispense treats to a pet animal when the pet toy is manipulated by the pet animal. The pet toy can include a housing having an interior surface and an exterior surface, where the interior surface defines a treat cavity for containing pet treats therein. The housing also includes at least a first housing aperture. A rotatable lid is attached to the housing and is disposed over a portion of the exterior surface that includes the first housing aperture. The rotatable lid includes at least a first lid aperture, where the rotatable lid is adapted to be rotated in relation to the exterior surface such that the first housing aperture can be exposed by the first lid aperture to form a treat passageway for the passage of treats through the housing.

According to one aspect, at least one of the housing and the rotatable lid also includes a second aperture, where the second aperture has a size that is smaller than either of the first housing aperture or the first lid aperture. In this manner, the rotatable lid can be rotated to a first position to form a treat inlet passageway adapted for inserting treats into the treat cavity and can also be rotated to a second position to form a treat outlet passageway adapted for dispensing treats from the treat cavity, where the treat outlet passageway has a size that is smaller than the treat inlet passageway. In this manner, treats can be easily and quickly loaded into the treat cavity by rotating the lid to form a larger treat inlet passageway and thereafter rotating the lid to form a smaller treat outlet passageway such that the release of treats from the treat cavity by the pet animal is regulated due to the smaller size of the treat outlet passageway in relation to the treat inlet passageway.

According to one aspect, the second aperture is a second lid aperture in the rotatable lid, where the larger treat inlet passageway is formed from the first lid aperture and the first housing aperture, and where the smaller treat outlet passageway is formed from the second lid aperture and the first housing aperture. Thus, the user can select the desired passageway by rotating the lid such that the desired lid aperture is disposed over the housing aperture.

According to another aspect, the second aperture is a second housing aperture in the housing. Thus, the treat inlet passageway can be formed from the first lid aperture and the first housing aperture, and the treat outlet passageway can be formed from the first lid aperture and the second housing aperture. In this manner, the lid can be rotated such that the first lid aperture is disposed over the first housing aperture to form the larger treat inlet passageway adapted for the insertion of treats, or is disposed over the second housing aperture to form the smaller treat outlet passageway.

According to another aspect, the rotatable lid is rotatable to a position such that treats disposed in the treat cavity cannot be released from the toy by the pet animal. In one aspect, each of the first and second housing apertures is sufficiently covered by the rotatable lid to prevent passage of treats through either of the first and second housing apertures. Accordingly, the exit of treats from the treat cavity can be prevented such that the animal cannot access the treats, without requiring the user to remove treats from the treat cavity. In this manner, the user can restrict the number of treats given to the pet animal at any given time by rotating the lid to close the treat cavity and the user is not required to remove the treats from the cavity.

According to one aspect, the pet toy has a substantially spherical shape to enable the pet toy to be rolled across a surface by a pet animal. In this regard, the rotatable lid can have a substantially hemispherical shape. In aspect, the substantially spherical pet toy can have an outer diameter of at least about 6 centimeters and not greater than about 10 centimeters, such that the pet toy can be used by a small pet animal such as a cat.

According to another aspect, the pet toy includes an inclined plane disposed within the treat cavity, where the inclined plane is adapted to move treats contained within the treat cavity, such as by moving the treats toward the treat outlet passageway, when the toy is rolled along a surface. For example, the inclined plane can be a helical surface extending through the treat cavity whereby the helical surface can move treats toward the treat outlet passageway when the toy is rolled in a particular direction.

According to another aspect, the pet toy can include a third housing aperture where the third housing aperture has a size that is smaller than the second housing aperture. In this manner, the difficulty of removing treats from the toy by the pet animal can be adjusted by selecting the desired housing aperture to form a passageway having the desired size. Further, this enables the use of treats having different sizes and shapes.

According to yet another aspect, the housing is sufficiently transparent to enable treats disposed within the treat cavity to be visible through the housing. This can advantageously increase the attraction of the pet toy to the pet animal.

According to another embodiment, a pet toy is provided that is adapted to dispense treats when the pet toy is manipulated by a pet animal. The pet toy can include a rigid housing having an interior surface and an exterior surface, where the interior surface defines a treat cavity for containing pet treats therein. The housing includes first and second housing apertures where the first housing aperture is larger than the second housing aperture. A rotatable lid is attached to the housing and is disposed over a portion of the exterior surface that includes the first and second housing apertures. The rotatable lid can include at least a first lid aperture where the rotatable lid is adapted to be rotated in relation to the exterior surface such that the first and second housing apertures can be selectively exposed by the lid aperture to form a passageway for the passage of treats through the housing.

According to one aspect of this embodiment, the pet toy is substantially spherical to enable the pet toy to be rolled across the surface by a pet animal. According to another aspect, an inclined plane is disposed within the treat cavity and is adapted to move treats contained within the treat cavity toward the second aperture when the pet toy is rolled along a surface by the pet animal in a particular direction. The inclined plane can be a helical surface extending through the treat cavity. According to a further aspect, the housing is sufficiently transparent to enable treats disposed within the treat cavity to be visible through the housing.

The present invention also provides a method for dispensing treats to a pet animal. In one embodiment, the method includes the step of providing a pet toy, where the pet toy includes a housing having an interior surface and an exterior surface where the interior surface defines a treat cavity for containing pet treats therein. At least a first housing aperture is provided in the housing. A rotatable lid is attached to the housing and is disposed over a portion of the exterior surface including the first housing aperture, where the rotatable lid includes at least a first lid aperture. The method also includes the step of rotating the rotatable lid in relation to the exterior surface to form a treat inlet passageway. Edible treats are placed within the treat cavity by inserting the treats through the treat inlet passageway. The rotatable lid is then rotated in relation to the exterior surface to form a treat outlet passageway. The pet toy can then be placed on a surface whereby treats can exit the treat cavity through the treat outlet passageway when a pet animal moves the pet toy along a surface.

According to one aspect, the method also includes the step of rotating the rotatable lid in relation to the exterior surface such that the rotatable lid covers the first housing aperture such that treats cannot exit the treat cavity when the pet toy is moved along the surface by the pet animal. According to another aspect, the pet toy is substantially spherical.

### DESCRIPTION OF THE DRAWINGS

FIGS. 1(a)-1(c) illustrate three perspective views of a pet toy for dispensing treats according to an embodiment of the present invention.

FIG. 2 illustrates a perspective view of a pet toy for dispensing treats according to an embodiment of the present invention.

FIG. 3 illustrates a cross-sectional view of a pet toy for dispensing treats according to an embodiment of the present invention.

FIGS. 4(a)-4(c) illustrate a top view of a pet toy for dispensing treats according to an embodiment of the present invention.

FIGS. 5(a)-5(d) illustrate a method for dispensing treats to a pet animal according to an embodiment of the present invention.

### DESCRIPTION OF THE INVENTION

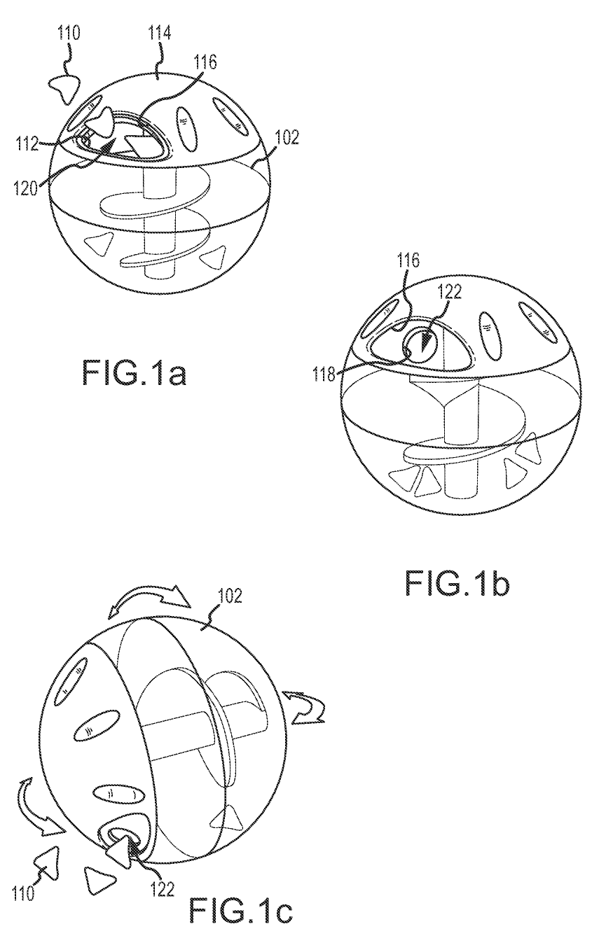

FIGS. 1(a)-1(c) illustrate perspective views of a pet toy that is adapted to dispense treats to a pet animal when the pet animal manipulates the toy by moving the pet toy along a surface.

The pet toy includes a housing 102 having an interior surface and an exterior surface. The interior surface defines a treat cavity for containing pet treats 110 therein. The pet treats 110 are preferably edible pet treats that have an aroma that is attractive to the pet animal.

A lid 114 is attached to the housing 102 and is adapted to be rotated in relation to the exterior surface of the housing 102. In FIG. 1(a), the lid 114 has been rotated to a position to expose a first housing aperture 112 by placing the lid aperture 116 over the first housing aperture 112. The first housing aperture 112 and the lid aperture 116 thereby form a treat inlet passageway 120 through which pet treats 110 can be easily placed within the treat cavity. That is, treat inlet passageway 120 is sufficiently large such that pet treats 110 can be quickly and easily placed within the treat cavity.

In FIG. 1(b), the lid 114 has been rotated to a position such that the lid aperture 116 now exposes a second housing aperture 118 that is smaller than the lid aperture 116 and is smaller than the first housing aperture 112. Thus, the lid aperture 116 and the second housing aperture 118 together form a treat outlet passageway 122 that is smaller (i.e. has a smaller cross-sectional area) than the treat inlet passageway 120 illustrated in FIG. 1(a).

FIG. 1(c) illustrates the toy being rolled along a surface such that treats 110 can pass through the treat outlet passageway 122. The treat outlet passageway 122 is sufficiently small such that the treats 110 are released from the toy at a controlled rate and are not rapidly dispensed from the toy when the pet animal rolls the toy along a surface.

The housing 102 illustrated in FIG. 1, is also sufficiently transparent to enable treats 110 disposed within the treat cavity to be visible to the pet animal through the housing 102. This will further encourage the pet animal to play with the pet toy since the pet animal will be able to visibly see the treats 110 disposed within the treat cavity. The user will also be able to readily determine how many treats remain in the treat cavity. For example, the housing 102 can be fabricated from a rigid transparent material, such as an acrylonitrile butadiene styrene (ABS) or a similar plastic material.

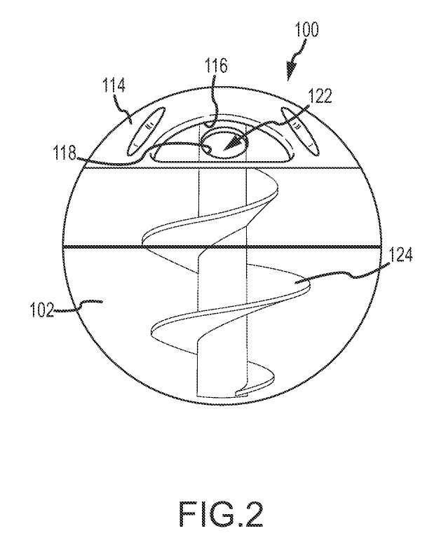

FIG. 2 illustrates a perspective view of the pet toy 100 for dispensing treats. The pet toy 100 includes a housing 102 and a rotatable lid 114 disposed on the housing. As illustrated in FIG. 2, the lid 114 is rotated to a position whereby the lid aperture 116 is disposed over the second housing aperture 118 to form a treat outlet passageway 122.

According to one embodiment of the present invention, the pet toy 100 includes an inclined plane that is adapted to assist the movement of treats toward the treat outlet passageway 122 when the pet toy is rolled along a surface by a pet animal. As is illustrated in FIG. 2, the inclined plane is a helical surface 124 that is disposed through the treat cavity. In this manner, as the pet animal moves the pet toy 100, the helical surface 124 will encourage the movement of treats toward the treat outlet passageway 122. Although illustrated as only extending partially toward the inner surface of the housing 102, the helical surface 124 can extend all the way to the inner surface of the housing 102 such that treats disposed in the treat cavity are forced to move on the inclined plane when the pet toy is rolled across a surface.

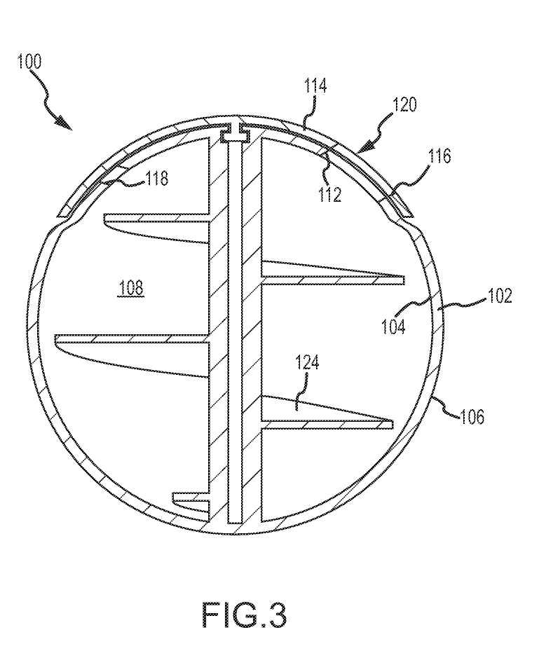

FIG. 3 illustrates a cross-sectional view of a pet toy according to an embodiment of the present invention. The pet toy includes a housing 102 having an exterior surface 106 and an interior surface 104 that defines a treat cavity 108.

The housing also includes a first housing aperture 112 and a second housing aperture 118, where the first housing aperture 112 is larger (i.e., has a larger cross-sectional area) than the second housing aperture 118. As illustrated in FIG. 3, the rotatable lid 114 has been rotated to a position whereby the lid aperture 116 exposes the first housing aperture 112 for placement of treats within the treat cavity 108 through a treat inlet passageway 120. After placement of treats in the treat cavity 108, the rotatable lid 114 can be rotated to a position such that the second housing aperture 118 is exposed by the lid aperture 116 to form a treat outlet passageway.

The pet toy 100 also includes a helical surface 124 that extends through the treat cavity 108. Accordingly, when the pet toy 100 is moved along a surface in a particular direction, the helical surface 124 will encourage movement of the treats toward the treat outlet passageway.

The pet toy illustrated in the figures is substantially spherical in shape to enable the pet toy to be easily rolled along a surface by a pet animal. In this regard, the lid 114 is hemispherical in shape and is set into a depression in the top of the housing 102 so that the pet toy 100 has such a substantially spherical shape. The pet toy can be sized to accommodate pet animals of a variety of sizes, and the diameter of the pet toy can be, for example, from about 6 centimeters to about 18 centimeters. In one embodiment, the pet toy 100 is sized to accommodate smaller pet animals such as cats and has an outer diameter of at least about 6 centimeters and not greater than about 10 centimeters.

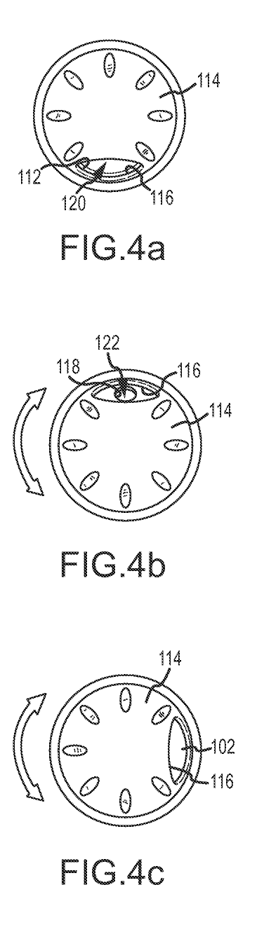

FIG. 4 illustrates a top view of a pet toy according to an embodiment of the present invention, and in particular illustrating the alternate positions of the lid with respect to the housing apertures. In FIG. 4(a), the rotatable lid 114 has been rotated to a position over the first housing aperture 112 to form a treat inlet passageway 120. In FIG. 4(b), the rotatable lid 114 has been rotated to a second position whereby the lid aperture 116 is disposed over the second housing aperture 118 to form a treat outlet passageway 122. In the embodiment illustrated in FIG. 4, the first housing aperture 112 and the second housing aperture 118 are disposed on opposite sides of the top of the housing (i.e., separated by about 180°).

The rotatable lid 114 can also be rotated to a position whereby treats disposed within the treat cavity cannot be released from the pet toy by the pet animal. Thus, in FIG. 4(c), the rotatable lid 114 has been rotated to a position whereby the lid aperture 116 is disposed over a solid portion of the housing 102 and does not expose a housing aperture, and therefore treats cannot be released from the treat cavity by the pet animal. In this manner, the lid 114 can be rotated to such a position and the pet animal can be permitted to continue playing with the pet toy without releasing treats from the pet toy, and advantageously without requiring removal of treats from the pet toy by the user.

According to another embodiment, the housing 102 can include a third housing aperture, such as one that has a size that is different than either of the first or second housing apertures. In one embodiment, the size of the third housing aperture is smaller than the second housing aperture. For example, a third housing aperture could be disposed on the top of the housing at a position opposite the position of the lid aperture illustrated in FIG. 4(c). This advantageously permits the difficulty of removing treats from the treat cavity to be increased as compared to the rotatable lid position illustrated in FIG. 4(b). Alternatively, this can also permit the use of different size treats with the pet toy.

It can be seen from the foregoing description that an advantage of the present invention is that the lid can be rotated to at least two different positions, a first position whereby a treat inlet passageway is formed and a second position whereby a treat outlet passageway is formed, where the treat outlet passageway has a size that is smaller that the treat inlet passageway. In an alternative embodiment to those illustrated in FIGS. 1-4, the rotatable lid can include a second aperture where the treat inlet passageway comprises the first lid aperture and a housing aperture and the treat outlet passageway comprises the second lid aperture and a housing aperture. Thus, the housing could include a single aperture where the lid includes two or more apertures and the lid is rotated to position the desired lid aperture over the housing aperture.

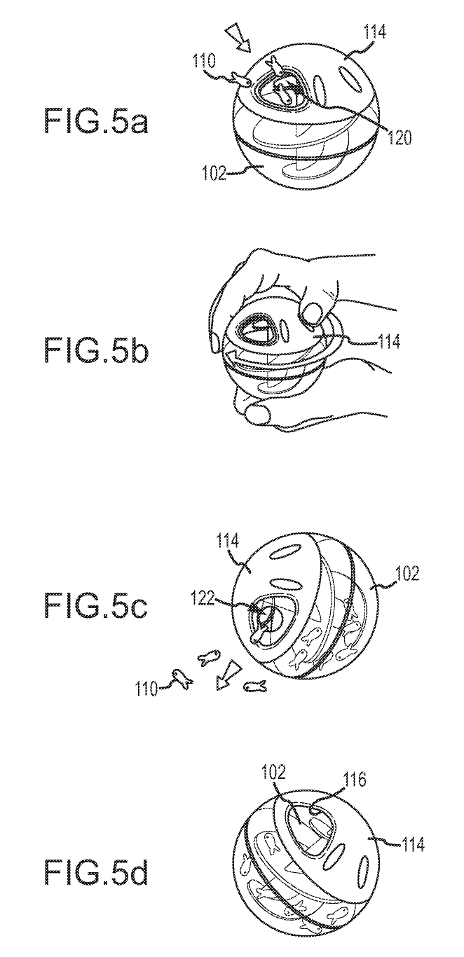

FIG. 5 graphically illustrates a method for dispensing treats to a pet animal according to an embodiment of the present invention. In FIG. 5(a), the rotable lid 114 has been rotated to a position in relation to the exterior surface of the housing 102 such that the first housing aperture is exposed by the lid aperture to form a treat inlet passageway 120. Edible treats 110 are placed within the treat cavity by inserting the treats 110 through the treat inlet passageway 120.

In FIG. 5(b), the rotatable lid 114 is rotated in relation to the exterior surface of the housing 102 to the position illustrated in FIG. 5(c) to cover the first housing aperture and expose a second housing aperture and form a treat outlet passageway 122 that is smaller than the treat inlet passageway 120. The pet toy can then be placed on a surface whereby treats 110 can exit the treat cavity through the treat outlet passageway 122 when a pet animal manipulates the pet toy on a surface.

As is illustrated in FIG. 5(d), the rotatable lid 114 can also be rotated to a position in relation to the exterior surface of the housing 102 such that the rotatable lid 114 covers both of the first and second housing apertures, such that treats 110 cannot exit the treat cavity when the pet toy is manipulated by a pet animal on a surface.

Thus, the pet toy advantageously enables edible treats to be easily and rapidly loaded into the pet toy. Thereafter, the user can easily reduce the size of the treat outlet passageway so that the treats are controllably released from the pet toy as the pet animal moves the pet toy along a surface. Further, the treat inlet passageway and treat outlet passageway can both be closed by simply rotating the lid to a fully closed position.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A pet toy adapted to dispense treats to a pet animal when the pet toy is manipulated by the pet animal, the pet toy comprising:
a housing having an interior surface and an exterior surface, said interior surface defining a treat cavity for containing pet treats therein;
at least a first housing aperture in said housing; and
a rotatable lid attached to said housing and disposed over a portion of said exterior surface that includes said first housing aperture, said rotatable lid comprising at least a first lid aperture, wherein said rotatable lid is adapted to be rotated in relation to said exterior surface such that said first housing aperture can be exposed by said first lid aperture to form a passageway for the passage of treats through said housing;
wherein at least one of said housing and said rotatable lid further comprises a second aperture, where said second aperture has a size that is smaller than either of said first housing aperture or said first lid aperture, such that said rotatable lid can be rotated to a first position to form a treat inlet passageway for inserting treats into said treat cavity, and can be rotated to a second position to form a treat outlet passageway comprising said second aperture for dispensing treats from said treat cavity, where said treat outlet passageway has a size that is smaller than said treat inlet passageway.

2. A pet toy as recited in claim 1, wherein said second aperture is a second lid aperture in said rotatable lid, wherein said treat inlet passageway comprises said first lid aperture and said first housing aperture and said treat outlet passageway comprises said second lid aperture and said first housing aperture.

3. A pet toy as recited in claim 1, wherein said second aperture is a second housing aperture in said housing, wherein said treat inlet passageway comprises said first lid aperture and said first housing aperture, and said treat outlet passageway comprises said first lid aperture and said second housing aperture.

4. A pet toy as recited in claim 3, wherein said rotatable lid is rotatable to a position such that each of said first and second housing apertures is covered by said rotatable lid to prevent passage of treats through either of said first and second housing apertures.

5. A pet toy as recited in claim 1, wherein said pet toy has a substantially spherical shape to enable the pet toy to be rolled across a surface by a pet animal.

6. A pet toy as recited in claim 5, wherein said rotatable lid has a substantially hemispherical shape.

7. A pet toy as recited in claim 5, wherein said pet toy has an outer diameter of at least about 6 centimeters and not greater than about 10 centimeters.

8. A pet toy as recited in claim 1, further comprising an inclined plane disposed within said treat cavity, said inclined plane being adapted to move treats contained within said treat cavity toward said treat outlet passageway when said pet toy is rolled along a surface.

9. A pet toy as recited in claim 8, wherein said inclined plane is a helical surface extending through said treat cavity.

10. A pet toy as recited in claim 3, further comprising at least a third housing aperture, wherein said third housing aperture has a size that is smaller than said second housing aperture.

11. A pet toy as recited in claim 1, wherein said housing is sufficiently transparent to enable treats disposed within said treat cavity to be visible through said housing.

12. A pet toy adapted to dispense treats when the pet toy is manipulated by a pet animal, comprising:
a rigid housing having an interior space and an exterior surface, said interior space defining a treat cavity for containing pet treats therein;
at least first and second housing apertures in said housing, wherein said first housing aperture is larger than said second housing aperture; and
a rotatable lid attached to said housing and disposed over a portion of said exterior surface that includes said first and second housing apertures, said rotatable lid comprising a lid aperture, wherein said rotatable lid is adapted to be rotated in relation to said exterior surface such that said first and second housing apertures can be selectively exposed by said lid aperture to selectively form a passageway for the passage of treats through said housing.

13. A pet toy as recited in claim 12, wherein said pet toy is substantially spherical to enable the pet toy to be rolled across a surface by a pet animal.

14. A pet toy as recited in claim 13, further comprising an inclined plane disposed within said treat cavity and being adapted to move treats contained within said treat cavity toward said second aperture when said pet toy is rolled along a surface.

15. A pet toy as recited in claim 13, wherein said inclined plane is a helical surface extending through said treat cavity.

16. A pet toy as recited in claim 12, wherein said housing is sufficiently transparent to enable treats disposed within said treat cavity to be visible through said housing.

17. A pet toy as recited in claim 12, wherein said rotatable lid can be rotated to a first position whereby said lid aperture and said first housing aperture form a treat inlet passageway, and can be rotated to a second position whereby said lid aperture and said second housing aperture form a treat outlet passageway that is smaller than said treat inlet passageway.

18. A method for dispensing treats to a pet animal, comprising the steps of:
providing a pet toy, the pet toy comprising:
a housing having an interior surface and an exterior surface, said interior surface defining a treat cavity for containing pet treats therein;
at least a first housing aperture in said housing;
a rotatable lid attached to said housing and disposed over a portion of said exterior surface including said first housing aperture, said rotatable lid comprising at least a first lid aperture;
rotating said rotatable lid in relation to said exterior surface to form a treat inlet passageway;
placing edible treats within said treat cavity by inserting the treats through said treat inlet passageway;
rotating said rotatable lid in relation to said exterior surface to form a treat outlet passageway that is smaller than said treat inlet passageway; and
placing said pet toy on a surface, whereby treats can exit said treat cavity through said treat outlet passageway when a pet animal manipulates said pet toy on the surface.

19. A method as recited in claim 18, further comprising the step of:
rotating said rotatable lid in relation to said exterior surface such that said rotatable lid covers said first housing aperture such that treats cannot exit said treat cavity when said pet toy is manipulated on a surface.

20. A method as recited in claim 18, wherein said pet toy is substantially spherical.
